(19) United States
(12) Patent Application Publication
(10) Pub. No.: US 2005/0144021 A1
(43) Pub. Date: Jun. 30, 2005

(54) Internet service charging method

(76) Inventors: Qi Guan, Wien (AT); Markus Lenger, Wien (AT)

Correspondence Address: Siemens Corporation;Intellectual Property Department, 170 Wood Avenue South, Iselin, NJ, 08830, US

(21) Appl. No.: 10/513,590

(22) PCT Filed: May 6, 2003
(86) PCT No.: PCT/EP03/04750

(30) Foreign Application Priority Data
May 7, 2002 (EP) 02010099.6

(51) Int. Cl. G06F 17/60

(52) U.S. Cl. 705/1

(57) ABSTRACT

The invention relates to a method for charging for Internet services, wherein the Internet users have access to the Internet via servers of an Internet provider and use the fee-paying services of various providers. According to said method the Internet provider refers the Internet users to pre-established providers. When a service is ordered by an Internet user from a pre-established provider, an order ID is issued by the computer of the user and said order ID is transmitted to the service provider and the Internet provider, thereby enabling anonymous use of services and ensuring a secure charging method.

### CROSS REFERENCE TO RELATED APPLICATIONS

This application is the US National Stage of International Application No. PCT/EP03/04750, filed May 6, 2003 and claims the benefit thereof. The International Application claims the benefits of European application No. 02010099.6 filed May 7, 2002, both applications are incorporated by reference herein in their entirety.

### FIELD OF INVENTION

The invention relates to a method for charging for Internet services, wherein the Internet users use the fee-paying services of various providers via servers of an Internet provider.

### BACKGROUND OF INVENTION

The use of fee-paying services from the Internet and the payment process connected therewith pose a certain risk to the user. On the one hand, the threat of malpractice exists when a conventional payment process involving charging via credit card companies is used, on the other hand the usual forwarding of telephone numbers and/or user names and addresses to the provider increases the risk of this data being passed on and the user being bothered with advertising mail, for example.

Systems for the secure transmission of credit card information were thus developed in order to safeguard the payment process, whereby a special encryption software is installed with both the user and also with the provider, the data thus being transmitted in encrypted format. The payment process is authorized using a central test centre, at which both parties must be registered.

The combination of credit cards and central registration can be perceived as disadvantageous here.

### SUMMARY OF INVENTION

The underlying object of the invention is thus to specify a method, whereby to a large extent user anonymity and free choice with regard to the payment process are guaranteed.

This is achieved in accordance with the invention using a method of the type mentioned at the beginning, wherein the Internet provider refers the Internet users to pre-established providers, and when a service is ordered by an Internet user from a pre-established provider, an order ID is issued by the computer of the user, and said anonymous order ID is transmitted to the provider and the Internet provider.

According to the inventive method, no sensitive user information is transmitted. The user ID is only known to the Internet provider, and is also not evident to the provider. The charging of the service is effected exclusively via the Internet provider, to whom a clear and trustworthy contractual relationship exists for the user.

It is advantageous if in addition to the order ID, an anonymous user ID created by the Internet provider and a service ID are sent to the provider and the Internet provider. In this way the charging of the services is simplified.

It is advantageous if with the dependency of the degree of charging on the duration of the use of the service, the anonymous order ID is periodically recurrently reissued during the duration of its use, at predetermined time intervals and transmitted to the provider and the Internet provider. It is therefore particularly advantageous when a service is ordered, if the user is referred to the charges accrued therefrom. For example, it is thus possible for a ‘call-charging equipment’ to be displayed in a window of the screen display. Displaying the charges for different services related to a specific time period is also conceivable, in other words, the display of an ‘account balance’.

The cost control is thus provided for the users even when the charging of services depends on the duration of the use. In particular, the charging is terminated in the event of a network failure or server failure. The possibility of cost control is of particular importance with this type of service, but is also advantageous with the use of services using subscription charging or service charging.

It is furthermore advantageous if the reference to pre-established providers is implemented on a portal of the Internet provider. General entry points of the internet are referred to as portals, on which the user is presented with standard offers.

It is furthermore favourable if, prior to the service provision, the provider enquires with the Internet provider as to whether or not the user is authorised to use this service. It is thus possible for a user for example to have certain services blocked, in other words, users with children can keep the use of special offer for adults exclusive to themselves.

### BRIEF DESCRIPTION OF THE DRAWING

The invention is illustrated in greater detail with reference to two Figures, which display the procedure of two different use and charging models for example, in which

FIG. 1 shows the procedure of a subscription or service controlled charging

FIG. 2 shows the procedure of a time-controlled charging of Internet services.

### DETAILED DESCRIPTION OF INVENTION

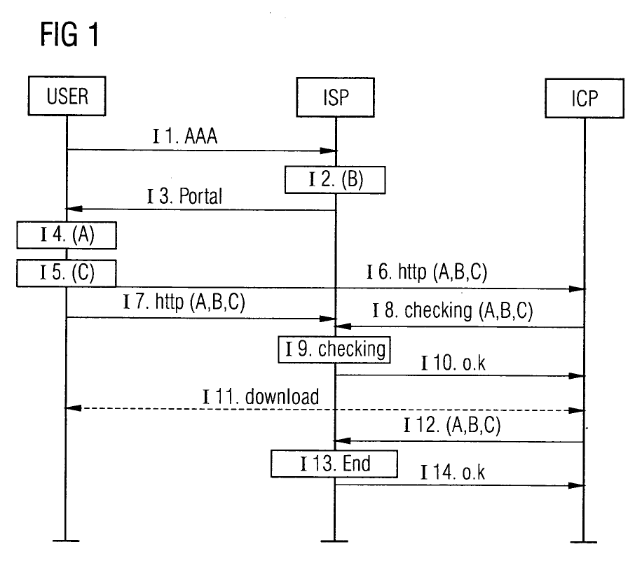

The procedure according to FIG. 1 relates to the request for a service which is charged as subscription. This means that with the payment for example, access to an Internet newspaper or database is secured for a specific period of time. Similarly the procedure can also be applied to the use of a service-controlled service such as downloading images, music samples or software for example.

In a first step I 1.AAA the connection between the user (USER) and Internet Service Provider ISP is established. For that purpose for example, the ‘Point to Point Protocol’ (PPP) can be used for Modem access, and the authentication of the user can hereby be activated.

With an already existing Internet Connection (e.g. by means of a third-party provider), the registration with the Internet provider takes place by means of Hyper Text Transfer Protocol (http).

This is also the case when the user USER reaches the provider ICP directly via the Internet and wants to use a service. The possibility then exists of a ‘Rerouting’ via the Internet provider IPS for authentication, which is necessary to control the inventive anonymous use and the charging of the service via the Internet provider ISP.

One prerequisite here is however that the provider ICP has a contractual relationship with the Internet provider ISP, in other words is one of the pre-established providers. In the next step I 2, an anonymous user ID B is generated and administered by the Internet provider (ISP) in confidence for the user (USER).

Subsequently in Step I3.Portal, the Offer portal, e.g. the homepage, is transferred together with the anonymous user ID B to the user USER. By means of the Internet Browser, the user is presented with the ISP portal with Links, in other words, cross-referenced to different services of one of a plurality of providers ICP.

The computer of the user generates an anonymous order ID A in Step I4. (A). This subsequently functions to identify the charging.

When the user decides on a specific service from a provider, and retrieves the corresponding display on the monitor of his computer by means of this selection (Step I5. (C)), a so-called http GET Request is sent in Step I. 6 http (A,B,C) from the computer of the user to the provider ICP, for a specific service, in accordance with Hyper Text Transfer Protocol.

The order (Request) contains an order ID A, the anonymous user ID B and a service ID C.

For the transaction control of the charging and as a confirmation of the service request, the anonymous order ID A generated by the computer of the user, the service ID C and the anonymous user ID is also sent to the Internet provider ISP by means of Hyper Text Transfer Protocol. (Step I 7.http (A,B,C)).

The provider ICP subsequently transmits (Step I 8.check (A,B,C) a request to the Internet provider (ISP) to establish whether or not the anonymous user USER is authorized to obtain the service. The anonymous order ID A is also sent for the authorisation confirmation and transaction control.

In Step I 9., the Internet provider ISP examines whether or not the user USER actually has authorization to use the service and issues its consent where necessary. (Step I 10.ok).

In the next method step I II.download, the desired data of the service is sent from the provider ICP to the user USER. As soon as the provider ICP receives the first confirmation that the data has reached the target computer, (e.g. via the TCP Protocol), it has the possibility to specify the anonymous order ID A with the ISP (‘to honour it’), so as to activate the charging (Step I. 12. (A,B,C)).

The Internet provider ISP now compares the order ID A and the service ID C, which it has received from the user USER and from the provider ICP (Step I 13. End) and transmits a concluding charging confirmation to the provider ICP (Step I 14.ok). This confirmation functions as a protocol for the charging for the provider (ICP).

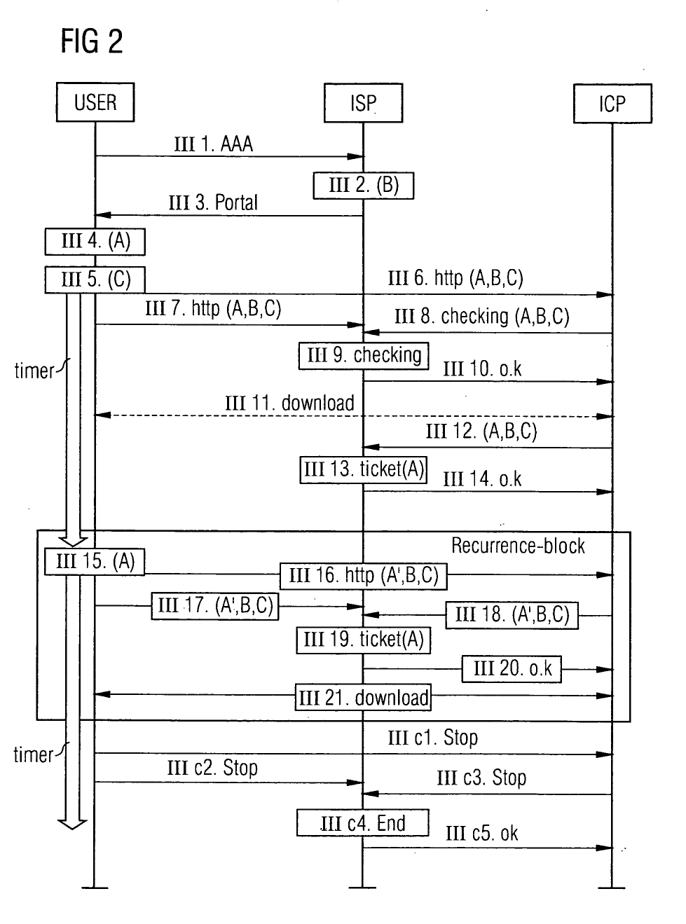

FIG. 2 shows the exemplary procedure of a time-controlled charging. The method steps III 1 to III 14 comply with the method steps I 1 to I 14 of the subscription-controlled charging. To supplement the method with the subscription or service controlled charging, the method steps for retrieving the service, the order (Request) and the Download (Steps III 15 to III 21 corresponding to III 5 to III 13 and 15 to I11) are repeated here in periodically recurring time intervals as long as necessary until the Download is terminated by the user (Step IIIe1.Stop and IIIe2.Stop), or the transmission is complete and the reference to the end of the download is effected by the provider (Step IIIe3.Stop).

Subsequently the charging is terminated by the Internet provider and the process is finished (Step III e4.End and III e5.ok).

During the entire procedure, the user is shown a ‘call charging equipment’ in a window of the screen display. This displays the charges accrued hitherto from ongoing use and a balance of accounts if so requested by the user, in other words, the services relating to a predetermined period in time, such as a week or a month for example or since the last accounting and the charges accrued therefrom.

1-6. (canceled)

7. A method of charging for internet services, comprising:
providing access for an Internet user to the Internet via a server of an Internet provider;
providing access for the Internet user to chargeable services of various service providers by the server;
referring the Internet user to pre-established service providers by the Internet provider;
issuing an order identification by the computer of the Internet user, when a service is ordered by the Internet user from a pre-established service provider; and
transmitting the order identification to the service provider and the Internet provider.

8. The method in accordance with claim 7, further comprising:
transmitting an anonymous user identification generated by the Internet provider and a service identification to the service provider and the Internet provider.

9. The method in accordance with claim 7, wherein the order identification is reissued in periodically recurring predetermined time intervals and sent to the service provider and the Internet provider, if a service charge related to a requested service is based on the duration of the requested service.

10. The method in accordance with claim 8, wherein the order identification is reissued in periodically recurring predetermined time intervals and sent to the service provider and the Internet provider, if a service charge related to a requested service is based on the duration of the requested service.

11. The method in accordance with claim 7, wherein the referring to the pre-established service provider is effected on a portal of the Internet provider.

12. The method in accordance with claim 8, wherein the referring to the pre-established service provider is effected on a portal of the Internet provider.

13. The method in accordance with claim 9, wherein the referring to the pre-established service provider is effected on a portal of the Internet provider.

14. The method in accordance with claim 7, wherein, when a service is ordered, the user is referred to the charges accrued thereby.

15. The method in accordance with claim 8, wherein, when a service is ordered, the user is referred to the charges accrued thereby.

16. The method in accordance with claim 9, wherein, when a service is ordered, the user is referred to the charges accrued thereby.

17. The method in accordance with claim 11, wherein, when a service is ordered, the user is referred to the charges accrued thereby.

18. The method in accordance with claim 7, wherein, prior to providing the service, the service provider verifies with the Internet provider whether the user is authorized to use this service.

19. The method in accordance with claim 8, wherein, prior to providing the service, the service provider verifies with the Internet provider whether the user is authorized to use this service.

20. The method in accordance with claim 9, wherein, prior to providing the service, the service provider verifies with the Internet provider whether the user is authorized to use this service.

21. The method in accordance with claim 11, wherein, prior to providing the service, the service provider verifies with the Internet provider whether the user is authorized to use this service.

22. A system for charging Internet services, comprising:
a server of an Internet provider for providing chargeable services of various service providers to an Internet user; and
a client computer of an Internet user to access the services provided by the server, wherein
the server is adapted to refer the Internet user to pre-established service providers, and wherein
the client computer is adapted to issue an order identification, when a service is ordered by the Internet user from a pre-established service provider, and to transmit the order identification to the service provider and the Internet provider.
